(19) United States
(12) Patent Application Publication
(10) Pub. No.: US 2024/0269818 A1
(43) Pub. Date: Aug. 15, 2024

(54) FRAMING HAMMER WITH OPPOSING RATCHET WRENCH

(71) Applicant: D&B Tool Designs, Shelbyville, IN (US)

(72) Inventors: Brad Bass, Shelbyville, IN (US); David Mohr, Shelbyville, IN (US)

(21) Appl. No.: 18/308,640

(22) Filed: Apr. 27, 2023

Related U.S. Application Data
(63) Continuation-in-part of application No. 18/182,787, filed on Mar. 13, 2023.
(60) Provisional application No. 63/485,029, filed on Feb. 15, 2023.

(51) Int. Cl. B25F 1/00

(52) U.S. Cl. CPC B25F 1/006; B25B 13/462; B25D 1/04

(57) ABSTRACT

A combination tool, including an elongated support member, a hammer portion operationally connected to the elongated support member, and a ratchet wrench portion operationally connected to the elongated support member and positioned opposite the hammer portion. The ratchet wrench portion has a generally circular aperture formed therethrough. The generally circular aperture defines a first plane and the ratchet assembly is disposed in the generally circular aperture. The ratchet assembly is rotatable around a first axis of rotation perpendicular to the first plane. The ratchet assembly further comprises a rotatable socket head and the rotatable socket head is rotatable about a second axis of rotation disposed orthogonally to the first axis of rotation. The socket head has socket four faces rotatable about the second axis of rotation, each respective face defining a socket size and shape.

### CROSS-REFERENCE TO RELATED APPLICATIONS

This patent application is a continuation-in-part of co-pending U.S. patent application Ser. No. 18/182,787, filed on Mar. 13, 2023, which claims priority to U.S. co-pending provisional patent application Ser. No. 63/485,029, filed on 15 Feb. 2023, which is incorporated herein by reference.

### TECHNICAL FIELD

The present novel technology relates generally to the field of hand tools, and more specifically to a combination framing hammer and ratchet wrench.

### BACKGROUND

A framer's primary tool is his framing hammer. However, framers often have to use other tools during the course of their job, including ratchet wrenches. As framers are already fairly laden with tools, equipment, and supplies, it would be advantageous to have to carry one less tool, as well as to not have to set down one tool, pick up another, and so on back and forth. Thus, there remains a need for an improved tool that would allow for less clutter and weight carried by a framer. The present novel technology addresses this need.

### BRIEF DESCRIPTION OF THE DRAWINGS

FIG. 1 is a perspective view of a combination hammer-multihead ratchet wrench according to a first embodiment of the present novel technology.

FIG. 2 is an enlarged partial perspective view of the hammer of FIG. 1 showing the multihead ratchet wrench portion.

FIG. 3 is an enlarged partial perspective cutaway view of the hammer of FIG. 2 showing the multihead ratchet wrench portion.

FIG. 4 is an enlarged partial perspective cutaway view of the hammer of FIG. 2 showing the multihead ratchet wrench support assembly portion without the multihued present.

FIG. 5 is a perspective view of a combination hammer-multihead ratchet wrench according to a second embodiment of the present novel technology.

FIG. 6 is an enlarged partial perspective view of the combination hammer-multihead ratchet wrench of FIG. 5 showing the multihead ratchet wrench portion.

FIG. 7 is a side plan view of the combination hammer-multihead ratchet wrench of FIG. 5.

FIG. 8 is an enlarged partial plan view of the combination hammer-multihead ratchet wrench of FIG. 7 showing the multihead ratchet wrench portion.

FIG. 9 is a side elevation view of the combination hammer-multihead ratchet wrench of FIG. 5.

### DETAILED DESCRIPTION

For the purposes of promoting an understanding of the principles of the claimed technology and presenting its currently understood best mode of operation, reference will now be made to the embodiments and specific language will be used to describe the same. It will nevertheless be understood that no limitation of the scope of the invention is thereby intended, with such alterations and further modifications in the illustrated device and such further applications of the principles of the claimed technology as illustrated therein being contemplated as would normally occur to one skilled in the art to which the claimed technology relates.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often, though may not always, occur and that the description includes instances where said event or circumstance occurs and instances where it does not.

The details of one or more embodiments of the subject matter described in this specification are set forth in the accompanying drawings and the description below. Other features, aspects, and advantages of the subject matter will become apparent from the description, the drawings, and the claims.

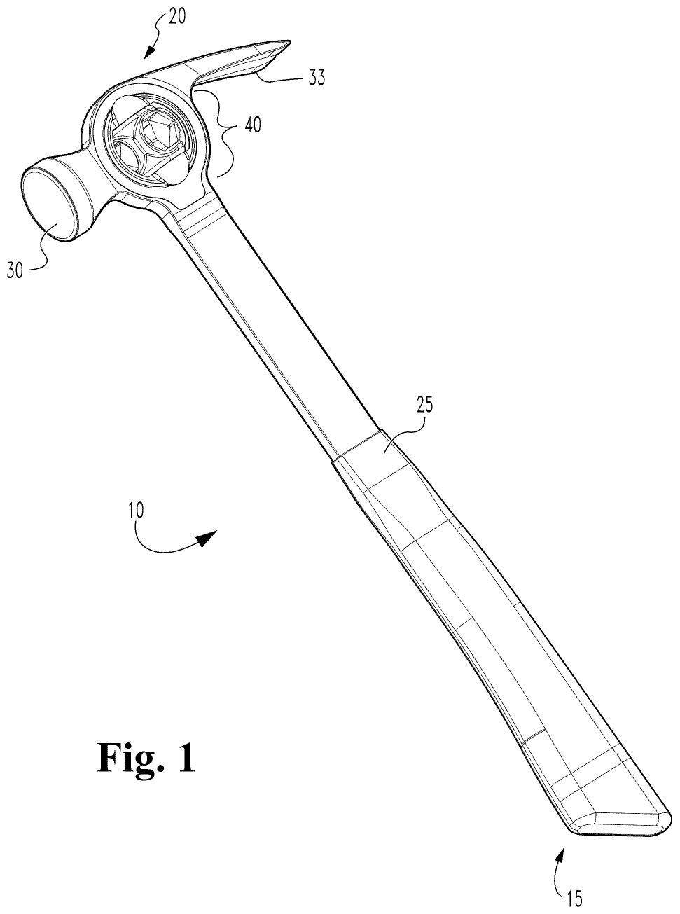

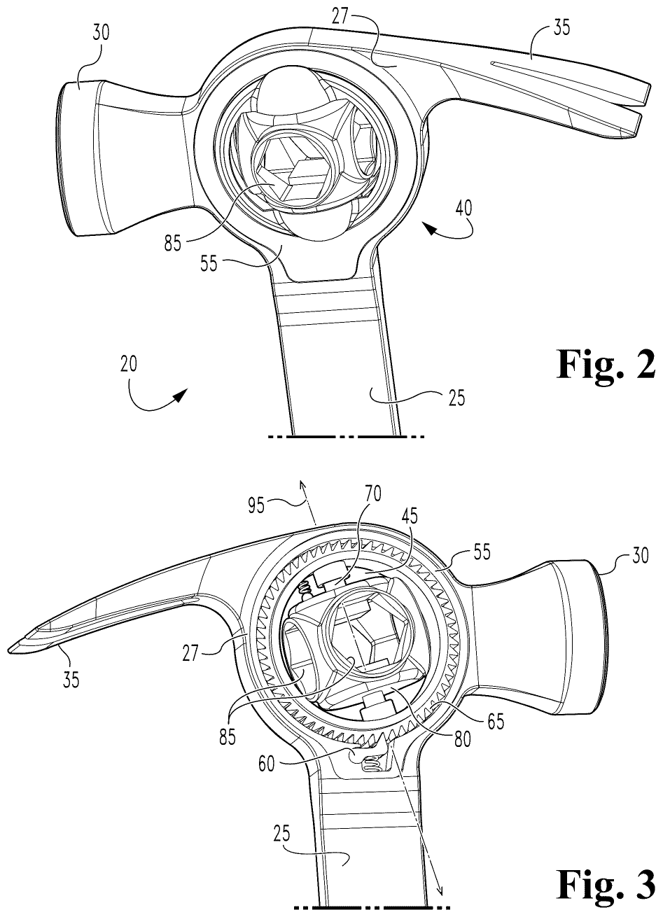

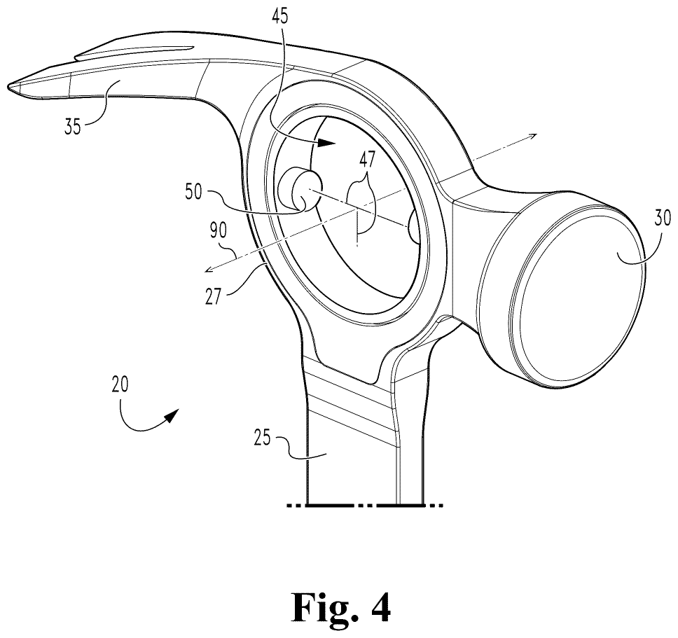

As illustrated in FIGS. 1-4, the present novel technology relates to a combination hammer/ratchet wrench assembly 10, referred to herein as framing hammer 10. Framing hammer 10 has a proximal or handle end 15 and an oppositely distal or hammerhead end 20 with a structural armature member 25 extending therebetween.

Distal end 20 includes a hammerhead support portion 27 having a hammer head 30 operationally connected thereto, an oppositely disposed generally flat elongated (typically bifurcated) prong portion 35 (also called claw herein portion) extending therefrom, and a ratchet assembly 40 operationally connected thereto and extending therethrough.

Ratchet assembly 40 further includes a (typically circular) opening 45 formed through the support portion 27 and accessible from either side, a least one engagement connector or pin 50 extending into the aperture 45, and a ratchet ring 55 operationally connected to the connector 50 and positioned within the aperture 45. Aperture 45 typically defines an aperture plane 47. Ratchet ring 55 further includes rotatable toothed outer ring 60 and a spring loaded pawl 65 positioned to lockingly engaged the toothed outer ring 60 such that rotation of the ring 60 is enabled in a first direction but prevented in a second, opposite direction by interaction of the pawl 65 with the toothed outer ring 60. Ratchet ring 55 further includes at least one pivot pin 70 for operationally engaging a rotatable socket head 75.

Rotatable socket head 75 has two opposing faces 80 for engaging the at least one pivot pin 70, which in typical embodiments is a pair of oppositely disposed pins 70 extending from the toothed ring 60 into the aperture 45. Socket head 75 may then be rotated around the pin(s) 70 such that on of several (typically four) socket faces 85 is oriented parallel with the aperture plane 47. Each respective socket face 85 defines a socket shape and size for connection to a tool or extension member. More typically, each respective socket face 85 defines a different, unique (to the socket head 75) socket shape and size, such as six or twelve point hexagonal, four point square, twelve point triple square, and like shapes, and half-inch, three-eighths inch, three-quarters inch, thirteen sixteenths inch, fifteen sixteenths inch, one and one-eighths inch, one and a quarter inch, 17 mm, 20 mm, and like sizes.

In operation, the instant framing hammer 10 is laid flat on a given surface and the socket head 75 rotated to expose the desired shape and size socket for a desired tool attachment. Male head of a desired tool or extension member is lockingly inserted into the matching female socket face 85. Extension and/or tool is then engaged with a workpiece, and the tool is rotated by rotating the hammer assembly in a first direction. The hammer assembly 10 is then ratcheted back in the second direction, so as to rotate the ratchet ring 55 relative to the hammer assembly 10, but not relative to the head 75/tool, the same as in any ratchet tool usage. Once the desired operation is completed, tool/extension is disengaged from the socket face 85 and set aside or otherwise stored. To perform the reverse operation, the hammer 10 may be flipped over so as to reverse the direction of free rotation of the ratchet ring 55, the appropriate socket face 85 is again dialed to present the selected face 85 to the user, the tool/extension head reinserted thereinto, and the hammer 10 is rotated/ratcheted in the reverse direction.

In some embodiments, the ratchet assembly 40 is unidirectional, while in other embodiments the ratchet assembly 40 is bidirectionally switchable.

In some embodiments, the socket head 75 is generally cubic with two opposing connection faces 80 and four rotatable socket faces 85. In other embodiments, socket head 75 includes a different number of rotatable faces 85, such as six, eight, or the like.

In general, the instant framing hammer assembly 10 is applicable to a wide variety of day-to-day tasks/labors that require both a hammer and a variety of sockets. The instant framing hammer 10 can be carried as a one-step solution to save time searching for multiple tools needed to complete a task. The physical appearance of the instant framing hammer assembly 10 is typically reminiscent of a classic style framing hammer, but with a four way ratcheting and selectable socket 40 set fixed into its head 27. The instant assembly 10 does not take away any utility of the assembly 10 to function as a framing hammer but adds ratchet wrench functionality thereto. The instant framing hammer assembly 10 typically weighs between 18 and 28 ounces, although the instant hammer assembly 10 may be of any convenient weight. The length of the hammer assembly 10 typically ranges from 14½ inches to 16 inches in total length (measured from top of the head to the tip of the handle) but may be made longer or shorter as is convenient.

The ratchet assembly 40 is rotatable about a first axis of rotation 90. First axis of rotation 90 is typically oriented perpendicular to and orthogonal with the aperture plane 47. The socket head 75 is rotatable about a second axis of rotation 95, which is typically disposed within or parallel to aperture plane 47 and is likewise oriented perpendicular to/orthogonally with first axis of rotation 90.

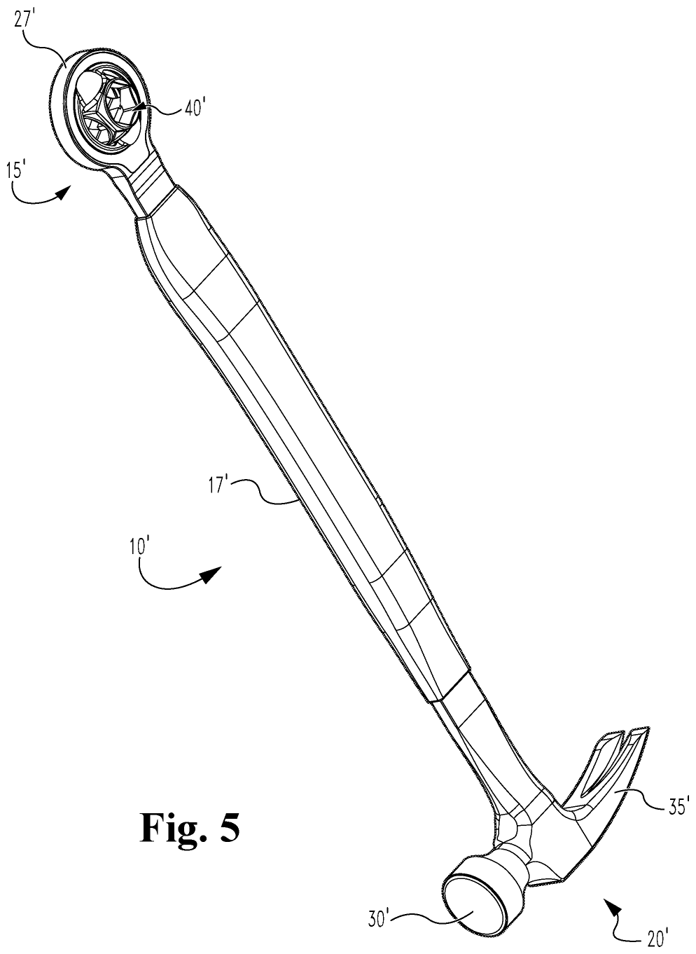

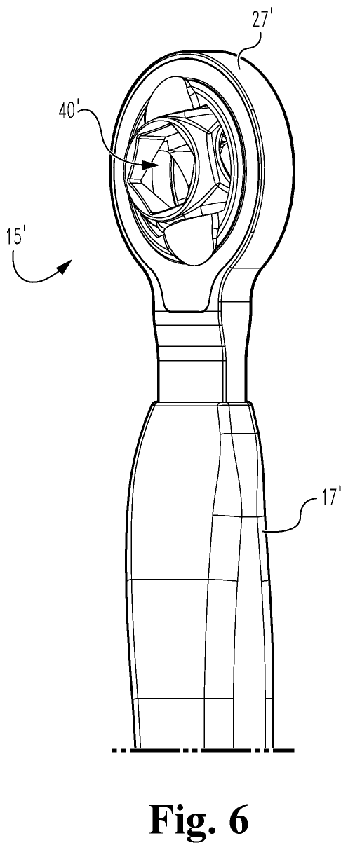

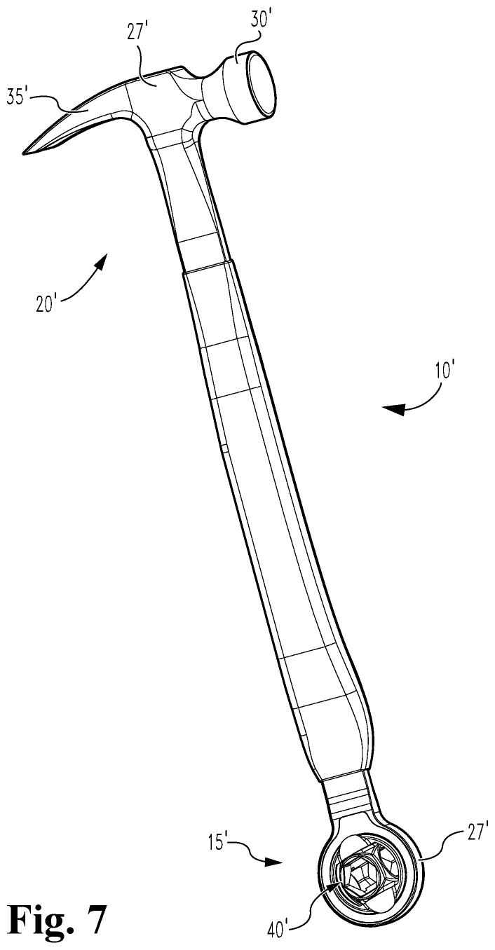

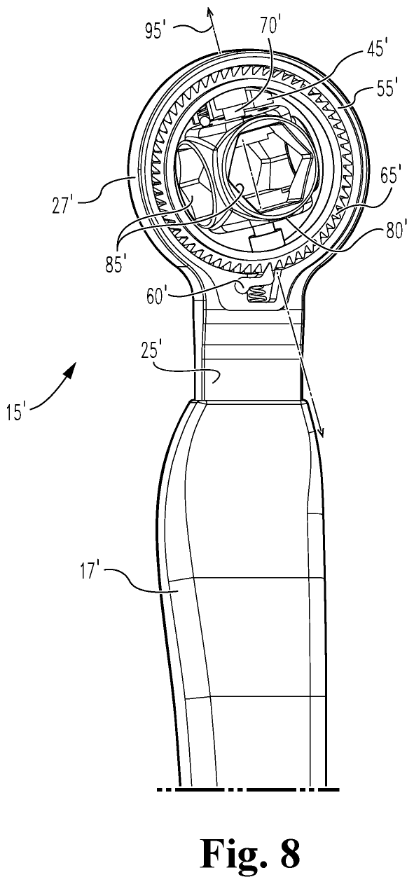

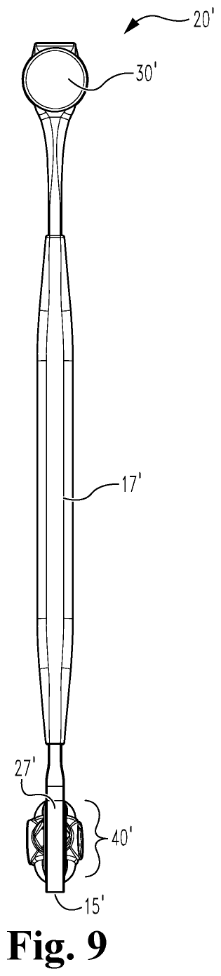

As illustrated in FIGS. 5-9, a second embodiment of the present novel technology relates to a combination hammer/ratchet wrench assembly 10′, referred to herein as framing tool 10′. Framing tool 10′ has a proximal or handle end 15′ and an oppositely distal or hammerhead end 20′ with a structural armature member 17′ extending therebetween.

Distal end 20′ includes a hammerhead support portion 27′ having a hammer head 30′ operationally connected thereto, an oppositely disposed generally flat elongated (typically bifurcated) prong portion 35′ (also called claw herein portion) extending therefrom.

Proximal end 15′ includes a support portion 27′, typically a ring of structural material, and a ratchet assembly 40′ positioned therein. Ratchet assembly 40′, like ratchet assembly 40 described above, further includes a (typically circular) opening 45′ formed through the support portion 27′ and accessible from either side, a least one engagement connector or pin 50′ extending into the aperture 45′, and a ratchet ring 55′ operationally connected to the connector 50′ and positioned within the aperture 45′. Aperture 45′ typically defines an aperture plane 47′. Ratchet ring 55′ further includes rotatable toothed outer ring 60′ and a spring loaded pawl 65′ positioned to lockingly engaged the toothed outer ring 60′ such that rotation of the ring 60′ is enabled in a first direction but prevented in a second, opposite direction by interaction of the pawl 65 with the toothed outer ring 60′. Ratchet ring 55′ further includes at least one pivot pin 70′ for operationally engaging a rotatable socket head 75′.

Rotatable socket head 75′ has two opposing faces 80′ for engaging the at least one pivot pin 70′, which in typical embodiments is a pair of oppositely disposed pins 70′ extending from the toothed ring 60′ into the aperture 45′. Socket head 75′ may then be rotated around the pin(s) 70′ such that on of several (typically four) socket faces 85′ is oriented parallel with the aperture plane 47′. Each respective socket face 85′ defines a socket shape and size for connection to a tool or extension member. More typically, each respective socket face 85′ defines a different, unique (to the socket head 75′) socket shape and size, such as six or twelve point hexagonal, four point square, twelve point triple square, and like shapes, and half-inch, three-eighths inch, three-quarters inch, thirteen sixteenths inch, fifteen sixteenths inch, one and one-eighths inch, one and a quarter inch, 17 mm, 20 mm, and like sizes.

In operation, the instant framing tool 10′ is laid flat on a given surface and the socket head 75′ rotated to expose the desired shape and size socket for a desired tool attachment. Male head of a desired tool or extension member is lockingly inserted into the matching female socket face 85′. Extension and/or tool is then engaged with a workpiece, and the tool is rotated by rotating the tool assembly 10′ in a first direction. The tool assembly 10′ is then ratcheted back in the second direction, so as to rotate the ratchet ring 55′ relative to the hammer assembly 10′, but not relative to the head 75′/tool, the same as in any ratchet tool usage. Once the desired operation is completed, tool/extension is disengaged from the socket face 85′ and set aside or otherwise stored. To perform the reverse operation, the tool 10′ may be flipped over so as to reverse the direction of free rotation of the ratchet ring 55′, the appropriate socket face 85′ is again dialed to present the selected face 85′ to the user, the tool/extension head reinserted thereinto, and the tool 10′ is rotated/ratcheted in the reverse direction.

In some embodiments, the ratchet assembly 40′ is unidirectional, while in other embodiments the ratchet assembly 40′ is bidirectionally switchable.

In some embodiments, the socket head 75′ is generally cubic with two opposing connection faces 80 and four rotatable socket faces 85′. In other embodiments, socket head 75′ includes a different number of rotatable faces 85′, such as six, eight, or the like.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

We claim:

1. A hand tool, comprising:
a handle member;
a head member; and
an elongated structural member connected to the handle member and to the head member;
wherein the head member further comprises:
a hammer support portion;
a hammer head portion operationally connected to the support portion;
an elongated bifurcated claw portion connected to the support portion and disposed opposite the hammer head portion;
wherein the handle member further comprises:
a ratchet support portion;
a generally circular aperture formed through the ratchet support portion;
a ratchet assembly positioned within the generally circular aperture;
a socket head rotatably connected to the ratchet assembly;
wherein the socket head includes at least four socket faces; and
wherein each respective socket face defines a socket shape and a socket size.

2. The hand tool of claim 1 wherein each respective socket face defines a different socket size.

3. The hand tool of claim 1 wherein the socket shape is selected from the group consisting of six point hexagonal, twelve point hexagonal, four point square, and twelve point triple square.

4. The hand tool of claim 2 wherein the socket size is selected from the group consisting of half-inch, three-eighths inch, three-quarters inch, thirteen sixteenths inch, fifteen sixteenths inch, one and one-eighths inch, one and a quarter inch, 17 mm, and 20 mm.

5. The hand tool of claim 1 wherein the ratchet assembly is unidirectional.

6. The hand tool of claim 1 wherein the socket head has four socket faces.

7. A combination tool, comprising:
an elongated support member;
a hammer portion operationally connected to the elongated support member; and
a ratchet wrench portion operationally connected to the elongated support member and positioned opposite the hammer portion;
wherein the ratchet wrench portion has a generally circular aperture formed therethrough;
wherein the generally circular aperture defines a first plane;
wherein a ratchet assembly is disposed in the generally circular aperture;
wherein the ratchet assembly is rotatable around a first axis of rotation perpendicular to the first plane;
wherein the ratchet assembly further comprises a rotatable socket head;
wherein the rotatable socket head is rotatable about a second axis of rotation disposed orthogonally to the first axis of rotation; and
wherein the socket head has socket four faces rotatable about the second axis of rotation, each respective face defining a socket size and shape.

8. The combination tool of claim 7 wherein each respective socket face defines a different socket size.

9. The combination tool of claim 7 wherein the ratchet assembly is unidirectionally rotatable around the first axis of rotation.

10. The combination tool of claim 7 wherein the hammer portion further comprises a hammer head portion and an oppositely disposed elongated claw portion.
